(19) United States
(12) Patent Application Publication
(10) Pub. No.: US 2006/0233130 A1
(43) Pub. Date: Oct. 19, 2006

(54) Apparatus and method for quality of service management in a wireless network

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/176,653

(22) Filed: Jul. 7, 2005

Related U.S. Application Data
(60) Provisional application No. 60/671,431, filed on Apr. 14, 2005.

(51) Int. Cl. H04Q 7/00

(52) U.S. Cl. 370/328

(57) ABSTRACT

An apparatus and method for QoS management including a wireless network having a plurality of base stations capable of communicating with a plurality of mobile stations in a coverage area of the wireless network, and having a packet classification element, configured to classify packets to be delivered to a mobile station; an information processing element, configured to process the packets from the packet classification element; and an information scheduler element, configured to coordinate delivery of the packets to the mobile station.

### CROSS-REFERENCE TO RELATED APPLICATION AND CLAIM OF PRIORITY

The present invention is related to that disclosed in U.S. Provisional Patent No. 60/671,431, filed Apr. 14, 2005. U.S. Provisional Patent No. 60/671,431 is assigned to the assignee of the present application. The subject matter disclosed in U.S. Provisional Patent No. 60/671,431 is hereby incorporated by reference into the present disclosure as if fully set forth herein. The present invention hereby claims priority under 35 U.S.C. §119(e) to U.S. Provisional Patent No. 60/671,431.

### TECHNICAL FIELD OF THE INVENTION

The present invention relates generally to wireless networks and, more specifically, to a system and method for quality of service management in a wireless network.

### BACKGROUND OF THE INVENTION

Quality of service (QoS) in a wireless network is primarily concerned with end-user experience, to assure that each user of the wireless system receives voice or data service that is both effective and pleasant to use. In packet-based wireless networks, quality of service is often addressed using one of two means, known to those of skill in the art: either the “Intserv” or “Diffserv” configuration.

In the Intserv approach, packets belonging to a flow (connection) are made to follow a fixed path, unlike in conventional data gram networks where each packet, in principle, can follow a different path to the destination). As the packets follow that fixed path, resources are reserved for that flow at intermediate routers on that path. This requires a connection set up phase using Resources Reservation Protocol (RSVP). Multiprotocol switching (MPLS) may be used to simplify switching at intermediate routers. This approach embodies virtual circuit methodology but suffers from poor scalability.

The Diffserv approach does not require a network-wide connection setup. It basically divides packets into several priority classes based on their QoS requirements. A field in the packet header, the type of service (TOS) byte, is used to identify the priority class. Packets belonging to a higher priority class receive differential treatment at each node. Since this differential treatment is only relative, a Diffserv based network cannot meet absolute QoS guarantees unless it is accompanied by a mechanism to control the amount of high-priority traffic admitted to the network. However the Diffserv approach scales well to large networks.

Each of these two approaches have benefits, but significant drawbacks. Therefore, there is a need in the art for an improved apparatus and method for quality of service management in a wireless network.

### SUMMARY OF THE INVENTION

A preferred embodiment provides an improved apparatus and method for quality of service management in a wireless network.

To address the above-discussed deficiencies of the prior art, it is a primary object of the present invention to provide a wireless network having a plurality of base stations capable of communicating with a plurality of mobile stations in a coverage area of the wireless network, comprising a packet classification element, configured to classify packets to be delivered to a mobile station; an information processing element, configured to process the packets from the packet classification element; and an information scheduler element, configured to coordinate delivery of the packets to the mobile station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which bandwidth is allocated in a dynamic and scalable manner according to the principles of the present invention;

FIG. 2 illustrates exemplary architectural additions to a wireless network, in accordance with an exemplary embodiment of the present invention.

### DETAILED DESCRIPTION OF THE INVENTION

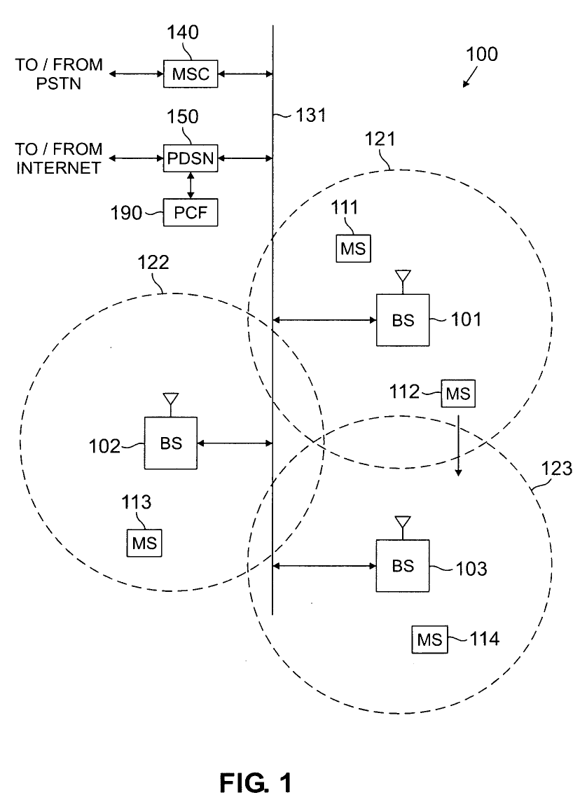

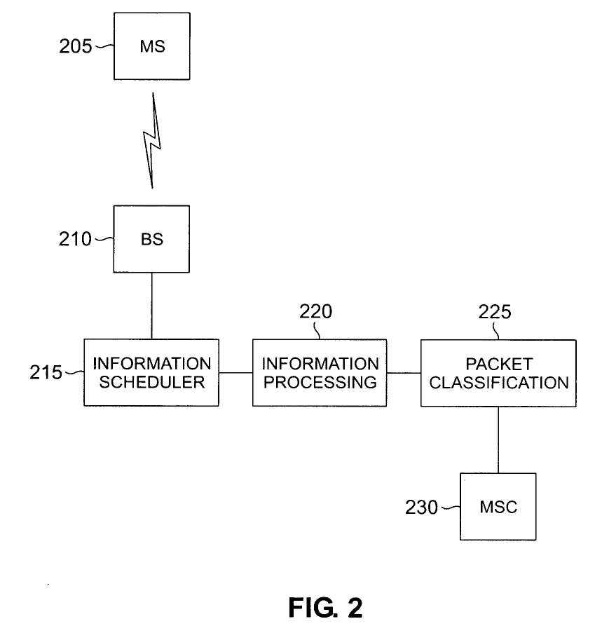

FIGS. 1 and 2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, in which bandwidth is allocated in a dynamic and scalable manner according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

Preferred embodiments include a system and method for QoS management in the next generation networks and or existing networks. The QoS management system is generically applicable and can form the basis of the any generation network independent of the physical medium.

Current and next generation networks are IP-based. In traditional IP (datagram) networks, there are no connection set-ups, and all traffic is handled in a best-effort manner. Consequently, the throughput, delay, delay jitter and packet losses suffered by connections are all subject to the statistical mature of network traffic. Managing QoS is difficult in such networks. However, as applications requiring guaranteed QoS gain in importance, IP networks have begun to incorporate features that will allow them to manage QoS in an effective manner.

A preferred embodiment includes a technique to implement both Intserv and Diffserv techniques, so as to guarantee QoS in wireless networks. The QoS management scheme combines the Intserv and Diffserv approaches to provide a flexible and scalable platform that can be used to deliver the desired QoS to a wide variety of applications.

As known to those of skill in the art, Intserv is a integrated services protocol architecture developed by the IETF, to provide QoS over the internet. IntServ requires applications to signal their service requirements to the network through a reservation request. Currently, Intserv uses RSVP as its end-to-end signalling protocol. Using RSVP, packets passing through a gateway host can be expedited based on policy and reservation criteria arranged in advance. IntServ is documented in RFC 1633, RFC 2212, and RFC 2215, all of which are hereby incorporated by reference.

Also as known to those of skill in the art, DiffServ is a differentiated services protocol architecture, developed by the IETF, to provide QoS over the internet. Diffserv is intended to address the scalability requirements for the global Internet which are not covered by IntServ. DiffServ works in the core of the network through a scalable aggregated service mechanism. In the DiffServ model, packets are classified as belonging to a flow if they have the same marking in their ToS byte (IPv4) or traffic-class byte (IPv6). Diffserv is documented in RFC 2474 and RFC 2475, which are both hereby incorporated by reference.

FIG. 2 illustrates exemplary architectural additions to a 3rd Generation Partnership Project 2 (3GPP2) wireless network, in accordance with an exemplary embodiment of the present invention. Of course, the architectural changes can be applied to any networks, as the suggestions are not purely tied to the physical medium.

In this figure, MS 205, BS 210, and MSC 230 can be implemented using standard mobile stations, base stations, and mobile switching centers, as described above with relation to FIG. 1. In the architecture shown in FIG. 2, three elements have been added between MSC 230 and BS 210: packet classification element 225, information processing element 220, and information scheduler element 215. Of course, in practice, the functions of these three elements can be performed by different elements, or be integrated into a single processing system, and can be implemented in other conventional portions of the network system.

The packet classification element 225 receives packets to be sent to mobile stations and sorts the packets out into different kinds of traffic classes and tags accordingly. The traffic classification can be constant bit rate, variable bit rate, (both real and non-real time) and unspecified bit rate. The classification is done also on the basis of the MAC, source or destination IP address, port numbers and combinations of all.

This ensures that the packets which are entering the network from the Internet world are properly binned for further processing by the information processing element.

Until the information has reached the packet classification element, the packets or the information are provided QoS according to the diffserv procedure.

The information processing element 220 receives the sorted information and then prioritizes the flow, and sends it accordingly to the information scheduler 215. The sending of the information to the information scheduler 215 is determined by the delay, jitter, and type of traffic requirements. The information processing element 225 therefore prioritizes the data in such a way that the packet flow can be delivered with the required QoS, if properly scheduled, taking into consideration the delay, jitter, or other impairments detected or anticipated in the transmission.

The information scheduler element 215 is where the actual scheduler resides for the traffic scheduling. Once the information is received by the information scheduler 215, from the information processing element 220, it will schedule the packet delivery to each mobile station accordingly on different data links and flows, using an Intserv approach, known to those of skill in the art. The scheduling is based on strict non-preemptive priorities and obeys per QoS class flow control. The scheduling is designed to handle the following constraints:

1) Ensuring low latency for high priority traffic

2) Elimination of idleness for high -priority traffic

3) Ensuring fairness in distribution of leftover capacity to the other traffic.

Thus, the QoS management utilizes distributed policing, scheduling and flow control, thus providing a flexible and scalable architecture. The disclosed scheme uses a combination of Intserv and Diffserv approaches: it uses IntServ like connection setups to ensure that critical resources within the networks have adequate capacity, while the Diffserv approach is evident in the packet transport. A tight link by link flow control practically eliminates packet losses within the network. The result is a scalable and dynamic QoS with provides the advantage of IntServ and Diffserv approach.

Although the present invention has been described with an exemplary embodiment, various changes and modifications may be suggested to one skilled in the art. It is intended that the present invention encompass such changes and modifications as fall within the scope of the appended claims.

What is claimed is:

1. A wireless network having a plurality of base stations capable of communicating with a plurality of mobile stations in a coverage area of the wireless network, comprising:
a packet classification element, configured to classify packets to be delivered to a mobile station;
an information processing element, configured to process the packets from the packet classification element; and
an information scheduler element, configured to coordinate delivery of the packets to the mobile station.

2. The wireless network as set forth in claim 1, wherein the packet classification element classifies packets into different traffic classes.

3. The wireless network as set forth in claim 1, wherein the packet classification element classifies packets into classes including constant bit rate, variable bit rate, and unspecified bit rate.

4. The wireless network as set forth in claim 1, wherein the packet classification element classifies packets into classes on the basis of the one or more of source IP address, destination IP address, and port numbers.

5. The wireless network as set forth in claim 1, wherein the packets to be classified by the packet classification element are managed using a diffserv protocol.

6. The wireless network as set forth in claim 1, wherein the information scheduler element prioritizes the packet flow of the packets.

7. The wireless network as set forth in claim 1, wherein the information scheduler element prioritizes the packet flow of the packets according to delay, jitter, and type of traffic requirements.

8. The wireless network as set forth in claim 1, wherein the information scheduler element schedules delivery of the packets to the destination mobile station by specifying data links and flows.

9. The wireless network as set forth in claim 1, wherein the information scheduler element schedules delivery of the packets to the destination mobile station using an Intserv protocol.
